(19) United States
(12) Patent Application Publication
(10) Pub. No.: US 2015/0347520 A1
(43) Pub. Date: Dec. 3, 2015

(54) USING CROWDSOURCING CONSENSUS TO DETERMINE NUTRITIONAL CONTENT OF FOODS DEPICTED IN AN IMAGE

(71) Applicant: Oracle International Corporation, Redwood Shores, CA (US)

(72) Inventors: Nigel KING, San Mateo, CA (US); Joseph GOLDBERG, San Carlos, CA (US)

(73) Assignee: Oracle International Corporation, Redwood Shores, CA (US)

(21) Appl. No.: 14/293,890

(22) Filed: Jun. 2, 2014

(51) Int. Cl. G06F 17/30

(52) U.S. Cl. CPC G06F 17/30525; G06F 17/30244; G06F 17/30867

(57) ABSTRACT

A method, system, and computer program product for wellness maintenance programs configured for user-specific tracking of food consumption to goals. Upon receiving a digital image of food or beverage items, the digital image is transmitted to a repository configured to serve a plurality of accesses by a plurality of human members (e.g., a crowdsource repository). Members of the crowd generate food description annotations pertaining to aspects of the pictured food or beverage items. The food description annotations (e.g., menu picks, text descriptions) are used to look-up nutrition records. Some use cases correlate a set of food description annotations that are shared between two or more of the human members to generate a confidence score, and some use cases also receive food intake recommendations from the human members. The food intake recommendations can be recorded in a wellness profile which in turn can be used for progress tracking against nutrition goals.

### RELATED APPLICATIONS

The present application is related to co-pending U.S. patent application Ser. No. ______, entitled, “OPTIMIZING WELLNESS PROGRAM SPENDING” (Attorney Docket No. ORA140562-US-NP), filed on even date herewith; and present application is related to co-pending U.S. patent application Ser. No. ______, entitled, “FORMING RECOMMENDATIONS USING CORRELATIONS BETWEEN WELLNESS AND PRODUCTIVITY” (Attorney Docket No. ORA140676-US-NP), filed on even date herewith, each of which are hereby incorporated by reference in their entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

The disclosure relates to the field of wellness maintenance programs with user-specific tracking of food consumption and more particularly to techniques for using crowdsourcing to determine nutritional content of foods depicted in an image.

### BACKGROUND

Good nutrition is essential to wellness. There is a large body of science regarding nutrition (e.g., nutrition minimum daily allowances, nutrition interactions, caloric content, calories from fat, calories from carbohydrates, etc.), and much of the science can be used within a wellness program. For example, a nutrition component of a wellness program might recommend that a particular user should endeavor to consume an average of not more than 2500 calories per day, and that no more than 500 of those calories should come from fat.

While such an endeavor is easy to articulate, it is not so easy to administer. For example, a user might have the intention to “stick to” a nutrition regimen, but actually counting nutrition and calories as food is consumed can be challenging. Legacy techniques have required the user to type in the number of calories consumed (e.g., after eating an portion of guacamole, type in 400 calories for a large portion, and 300 calories for a small portion, type in an additional 250 calories for the tortilla chips). Other legacy techniques have attempted to aid the user by offering a list of foods and a means for selecting items from among the list. Such legacy techniques are deficient in that the burden placed on the user is far too high—especially when the user is asked to track intake for all foodstuff consumed each and every day, and on an ongoing basis.

Some attempts to reduce the burden placed on the user have involved use of crowdsourcing, where an image of the food that has been consumed (or that which is soon to be consumed) is sent to a crowd, and people in the crowd are asked to assess the caloric content of the food in the image. This technique falls short. First, the range of calories assessed by one member of the crowd versus another user of the crowd has been shown to be extreme—and extreme to the extent that the calorie counts from the crowd are deemed to be unreliable. Second, merely reporting calorie counts fails to account for nutritional content of the foods. What is needed is a technique or techniques to receive reliable descriptions of food items, and to use those reliable descriptions of food items to cross-reference into reliable nutrition corpora.

None of the aforementioned legacy approaches achieve the capabilities of the herein-disclosed techniques for using crowdsourcing consensus to determine nutritional content of foods depicted in an image. Therefore, there is a need for improvements.

### SUMMARY

The present disclosure provides an improved method, system, and computer program product suited to address the aforementioned issues with legacy approaches. More specifically, the present disclosure provides a detailed description of techniques used in methods, systems, and computer program products for using crowdsourcing to determine nutritional content of foods depicted in an image.

Some embodiments commence upon receiving a digital image of food or beverage items, and then transmitting the digital image to a repository configured to serve a plurality of accesses by a plurality of human members (e.g., a crowdsource repository). Members of the crowd generate food description annotations pertaining to aspects of the pictured food or beverage items. The food description annotations (e.g., menu picks, text descriptions) are used to look-up nutrition records. Some use cases correlate a set of food description annotations that are shared between two or more of the human members to generate a confidence score, and some use cases also receive food intake recommendations from the human members. The food intake recommendations can be recorded in a wellness profile which in turn can be used for progress tracking against nutrition goals.

Further details of aspects, objectives, and advantages of the disclosure are described below and in the detailed description, drawings, and claims. Both the foregoing general description of the background and the following detailed description are exemplary and explanatory, and are not intended to be limiting as to the scope of the claims.

### BRIEF DESCRIPTION OF THE DRAWINGS

FIG. 1A depicts a data flow using crowdsourcing to determine nutritional content of foods depicted in an image, according to some embodiments.

FIG. 1B exemplifies a wellness application environment including using crowdsourcing to determine nutritional content of foods depicted in an image, according to some embodiments.

FIG. 2 depicts a consensus processor subsystem as implemented within a wellness program that uses crowdsourcing to determine nutritional content of foods depicted in an image, according to some embodiments.

FIG. 3 shows a transformation process as implemented by a service bureau in conjunction with a wellness program that uses crowdsourcing to determine nutritional content of foods depicted in an image, according to some embodiments.

FIG. 4 presents a data flow of an XML data item within a wellness program that uses crowdsourcing to determine nutritional content of foods depicted in an image, according to some embodiments.

FIG. 5A presents a control panel user interface as used within a wellness program that uses crowdsourcing to determine nutritional content of foods depicted in an image, according to some embodiments.

FIG. 5B presents a nutrition target user interface as used within a wellness program that uses crowdsourcing to determine nutritional content of foods depicted in an image, according to some embodiments.

FIG. 5C presents a photo upload user interface as used within a wellness program that uses crowdsourcing to determine nutritional content of foods depicted in an image, according to some embodiments.

FIG. 5D presents a nutrition correspondence user interface as used within a wellness program that uses crowdsourcing to determine nutritional content of foods depicted in an image, according to some embodiments.

FIG. 5E presents a nutrition tracker user interface as used within a wellness program that uses crowdsourcing to determine nutritional content of foods depicted in an image, according to some embodiments.

FIG. 6 is a block diagram of a system for using crowdsourcing to determine nutritional content of foods depicted in an image, according to some embodiments.

FIG. 7 depicts a block diagram of an instance of a computer system suitable for implementing embodiments of the present disclosure.

### DETAILED DESCRIPTION

Some embodiments of the present disclosure address the problem of determining nutritional content of food in a meal. More particularly, disclosed herein and in the accompanying figures are exemplary environments, methods, and systems for using crowdsourcing to determine nutritional content of foods depicted in a photograph.

### Overview

A user can take a photo of his or her meal, and upload the photo to a crowdsourcing platform. The caloric content and other attributes of the meal can be identified or discussed by members of the crowd, and attributes of the meal that are deemed to be statistically reliable (e.g., using a statistical confidence interval and a threshold) and/or trending toward a consensus can be used in recording content and/or other aspects of the meal on behalf of the user. For example, if a user were to take a picture of a “big burger combo meal”, a viewer might be able to identify the foodstuff in the photo (e.g., as a “big burger combo meal”). Then, the identification can be used in a lookup operation to determine nutritional characteristics of the meal. For example, given an identification of foodstuff in a photo in the form of a text string comprising, “big burger combo meal”, a lookup operation might return a well-researched nutrition description. Continuing this example, a “big burger combo meal” might be known to comprise 980 calories, which includes 29 grams of fat, and includes 1040 mg of sodium. Still more nutrition-related information might be included in the nutrition description, such as pertaining to cholesterol, proteins, and a listing of vitamins and minerals (e.g., potassium and calcium) so as to track the contribution of the meal against daily requirements for those nutrients.

The aforementioned crowdsourcing platform might be any crowdsourcing platform where users perform tasks free or for token amounts of money or for recognition. Strictly as one example, one crowdsourcing implementation called the “Mechanical Turk” supports many different projects. Such projects often comprise tasks where a given task requires very little time from a human in exchange for some small measure of notoriety and/or a small amount of compensation (e.g., winning a game or scoring points or receiving micro-payments).

Crowdsourcing projects can be hosted in a manner such that when a user chooses a task, the user would have a higher likelihood of “winning” and/or of receiving other recognition or compensation if a particular type of task is selected. Over time, users would tend to select tasks that hold a higher likelihood of returning recognition or compensation (e.g., winning a game or scoring points or receiving micro-payments).

In some cases the results of a crowd can be filtered to as to remove wrong or incomplete responses, and in some cases human or automated referees can be employed so as to select-in or reject-out crowdsourcing results so as to achieve acceptable statistical measures over a population of crowdsource-generated descriptions.

There may be a time delay between the time that a user takes a photo of his or her meal (e.g., for upload to a crowdsourcing platform) and the time that the crowdsourcing results from the uploaded photo achieve acceptable statistical consensus (e.g., consensus or confidence based on the characteristics of a population of corresponding crowdsource-generated descriptions).

The following figures and descriptions show and describe techniques for implementing crowdsourcing into a wellness program.

### DEFINITIONS

Some of the terms used in this description are defined below for easy reference. The presented terms and their respective definitions are not rigidly restricted to these definitions—a term may be further defined by the term's use within this disclosure.
The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.
As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances.
The articles “a” and “an” as used in this application and the appended claims should generally be construed to mean “one or more” unless specified otherwise or is clear from the context to be directed to a singular form.

Reference is now made in detail to certain embodiments. The disclosed embodiments are not intended to be limiting of the claims.

### DESCRIPTIONS OF EXEMPLARY EMBODIMENTS

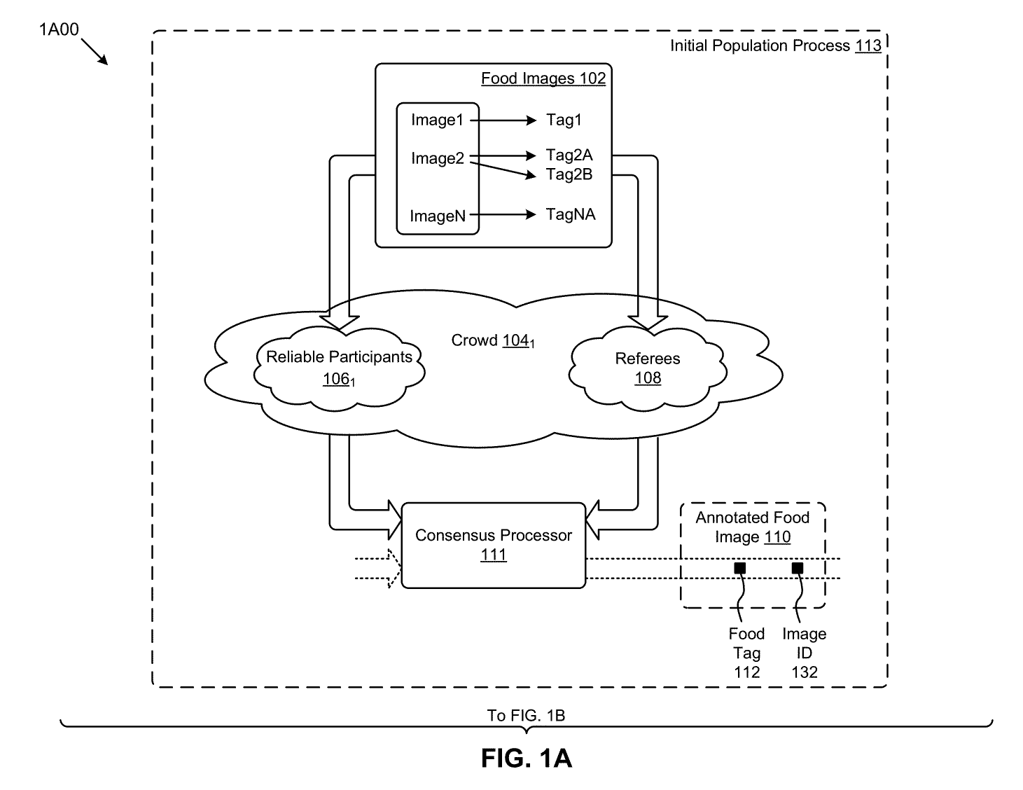

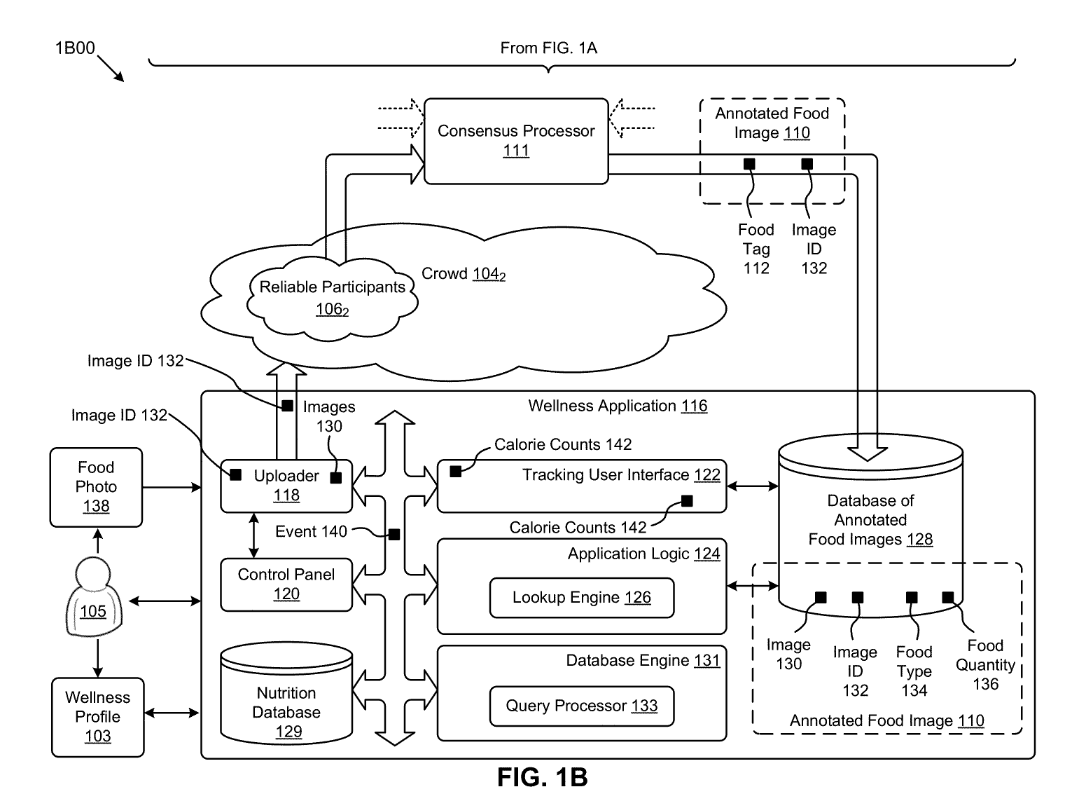

FIG. 1A depicts a data flow using crowdsourcing to determine nutritional content of foods depicted in an image. As an option, the data flow 1A00 or any aspect thereof may be implemented in the context of the architecture and functionality of the embodiments described herein.

As shown in FIG. 1A, food images 102 (e.g., Image1, Image2, ImageN) together with corresponding image tags (e.g., Tag 1, Tag2A, Tag2B, TagNA) are sent to a crowd (e.g., crowd 104₁) to be used as a training and/or calibration set for a consensus processor 111. A selected set of food images might be photos (e.g., digital images) of meals, and the tags correspond to characteristics of the image and/or characteristics of food in the photo. For example, a photo of a “big burger combo meal” might described and/or be tagged as a “big lunch” and further might be tagged as comprising a total caloric content of 980 calories, fat content of 29 grams, and sodium content of 1040 mg. Still more nutrition-related information might be included in the nutrition description, such as pertaining to cholesterol, proteins, and a listing of vitamins and minerals, etc.

The food images are sent to the crowd. Some of the images are sent to the crowd without the tags, and participants in the crowd are tasked with adding tags. Also, sometimes in parallel, some of the images are sent to the crowd with the tags, and referees 108 in the crowd 104 are tasked with adding tags selected from the given tags. Using the responses from the crowd in combination with responses from referees 108, a subset of the crowd can be identified (see reliable participants 106₁). For example, tags received from the referees 108 can be compared to tags received from others, and tag responses that deviate statistically from the responses from the referees might be considered to be coming from unreliable participants. A set of responses from the crowd, in particular a selection of responses from reliable participants 106₁, can serve to training a learning model or other classifier within the consensus processor.

A configured consensus processor can be used to automatically add and possibly fill-out a set of food tags (e.g., food tag 112) pertaining to an image based on a smaller set of food tags. For example, if a crowd reports consensus that a photo of a “big burger meal” is accurately described as a “Big Whopping Meal” (e.g., from the menu of the “Big Whopping Burger” chain of restaurants), then the remaining nutrition information can be added to the food image.

The initial population process 113 can commence at any time and results of the initial population process can serve to tag images with known and/or refereed annotations, which annotations can be stored together with corresponding images in an annotated food image database. Also, at any point in time a newly photographed food item can be uploaded to crowd 104₂ (see FIG. 1B), and participants (e.g., reliable participants 106₂) from the crowd can produce a corresponding instance of an annotated food image 110, which in turn is stored in an annotated food image database.

FIG. 1B exemplifies a wellness application environment 1B00 that uses crowdsourcing to determine nutritional content of foods depicted in an image.

An enterprise might sponsor a wellness program having incentives and having a wellness application 116 to aid employees in formulating wellness goals and for tracking achievement toward goals. To facilitate tracking, a user 105 can take a food photo 138 (e.g., using a smart phone), and upload it to a crowd using the computer-aided assistance of a wellness application user interface (e.g., a user interface pertaining to an uploader 118 and/or a user interface pertaining to a control panel 120). In exemplary situations, a user can interact with a tracking user interface 122, which in turn interacts with application logic 124. The application logic can receive an event 140 (e.g., the event attached to or corresponding to a respective food photo) and can perform a lookup (e.g., using lookup engine 126). The lookup engine in turn accesses a database of annotated food images 128 comprising an image 130, an image ID 132, a description of a food type 134, and a food quantity 136. Annotations for any number of, or ranges of, food types can be described in any form, including being described in a tabular form, such as is depicted in Table 1.

TABLE 1
Food Annotations

| ImageID | Food Type | Food Quantity | Quantity Units |
|---|---|---|---|
| 0001 | Toast | 1 | Slice |
| 0002 | Fried eggs | 2 | Whole eggs |
| 0003 | Sausage | 4 | Links |
| 0004 | Mashed potatoes | 250 | Grams |
| 0005 | Mashed potatoes | 1 | Large portion |

As heretofore mentioned, an enterprise might sponsor a wellness program including a wellness application 116 to aid employees in formulating wellness goals and for tracking achievement toward goals. To facilitate tracking, a user 105 can interact with a wellness application user interface which in turn interacts with application logic 124 to process instances of annotated food images 128. For example, application logic 124 may use a lookup engine to 126 to retrieve annotated food images that correspond to a food photo 138 as photographed and uploaded by the user. In exemplary cases, the food image is photographed contemporaneously with the act of consuming the food, and the event 140 can codify aspects (e.g., time, date, place, etc.) of the act of consuming the food. Any number of events, together with a food photo 138 can be collected and stored, and at any moment in time, the nutritional content (e.g., calories, protein, carbohydrates, etc.) of the foodstuff in the food image can be queried from the database of annotated food images. Calorie counts 142 and other summary information (e.g., average sodium per day, etc.) can be returned and from a query. In some cases the aforementioned query might not return food types and/or food quantity corresponding to the event as recorded by the food image. In such a case, aspects of the event are not included in the summary information, and at some later moment in time, the crowd might produce an annotated food image 110, which is then stored in the database of annotated food images 128 in a form that can be queried (e.g., by lookup engine 126).

Using the crowd, the food items pictured in a food photo 138 can be identified and, once identified, the nutritional content can be looked up in a nutrition database 129, possibly using a query processor 133 and a database engine 131. Ambiguity and/or omissions and/or errors in the database of annotated food images can be reduced by using data processing techniques within the consensus processor. Strictly as one example, to a first observer, a moderate portion of blanched lean chicken breast might look the same as a very large portion of mozzarella cheese, and the observer might report the image a containing a very large portion of mozzarella cheese. Yet multiple observers might see a moderate portion of blanched lean chicken breast, and a consensus across the multiple observers can improve reliability of crowd-sourced results. A subsystem for implementing various data processing techniques, including a consensus processor is shown and discussed as follows.

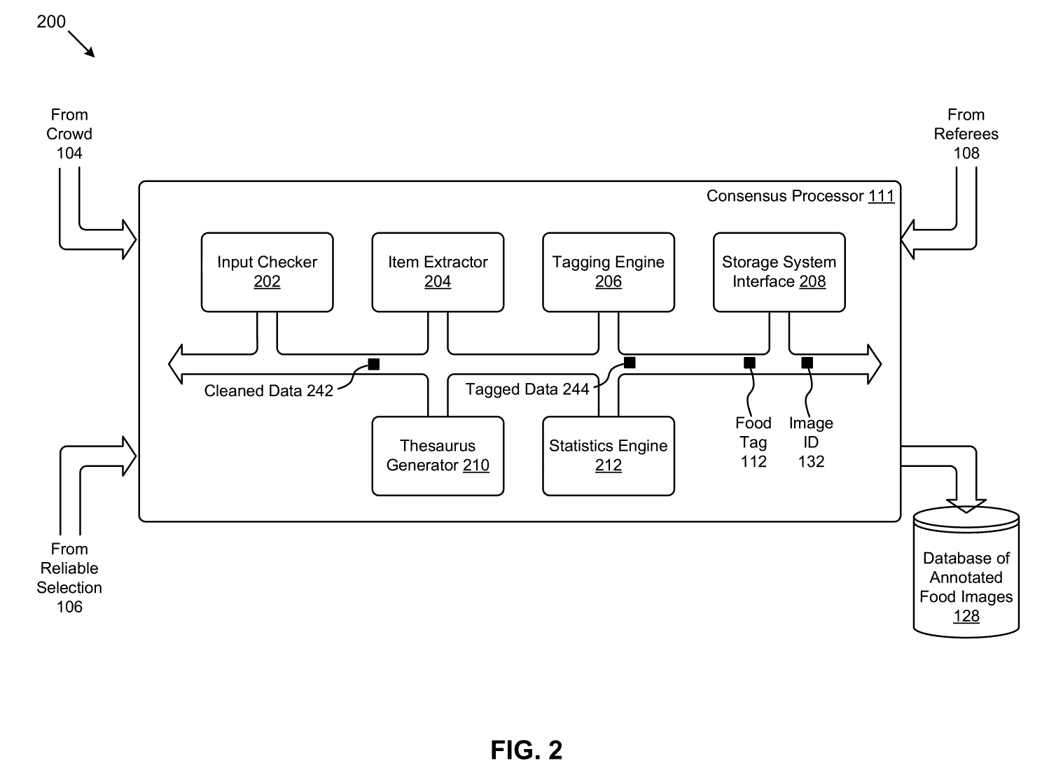

FIG. 2 depicts a consensus processor subsystem 200 as implemented within a wellness program that uses crowdsourcing to determine nutritional content of foods depicted in an image. As an option, one or more instances of consensus processor subsystem 200 or any aspect thereof may be implemented in the context of the architecture and functionality of the embodiments described herein. Also, the consensus processor subsystem 200 or any aspect thereof may be implemented in any desired environment.

As shown in FIG. 2, the consensus processor received data from the crowd, and any number of steps are taken to clean the received data, to tag the data, to assemble a thesaurus, and to perform various statistics on the data vis-à-vis previously stored annotated food images. Strictly as one example, processing received data from the crowd might proceed by cleaning the received data of bad input and/or checking the incoming data for adherence to a particular syntax. An input checker 202 can perform such cleaning, and cleaned data 242 can be received by an item extractor 204 that serves to extract information from the data that can be used as a tag. A tagging engine 206 takes suspected tags and/or tag values and codifies the tags and tag values into a form for further processing. Further processing might include assembling and/or adding to a thesaurus using a thesaurus generator 210. Further processing might also include using a statistics engine 212 to determine the degree of consensus in the received tags and tag values as compared with other tags and tag values pertaining to the same image. The results (e.g., tagged images, thesaurus entries, statistics values, etc.) are stored using storage system interface 208.

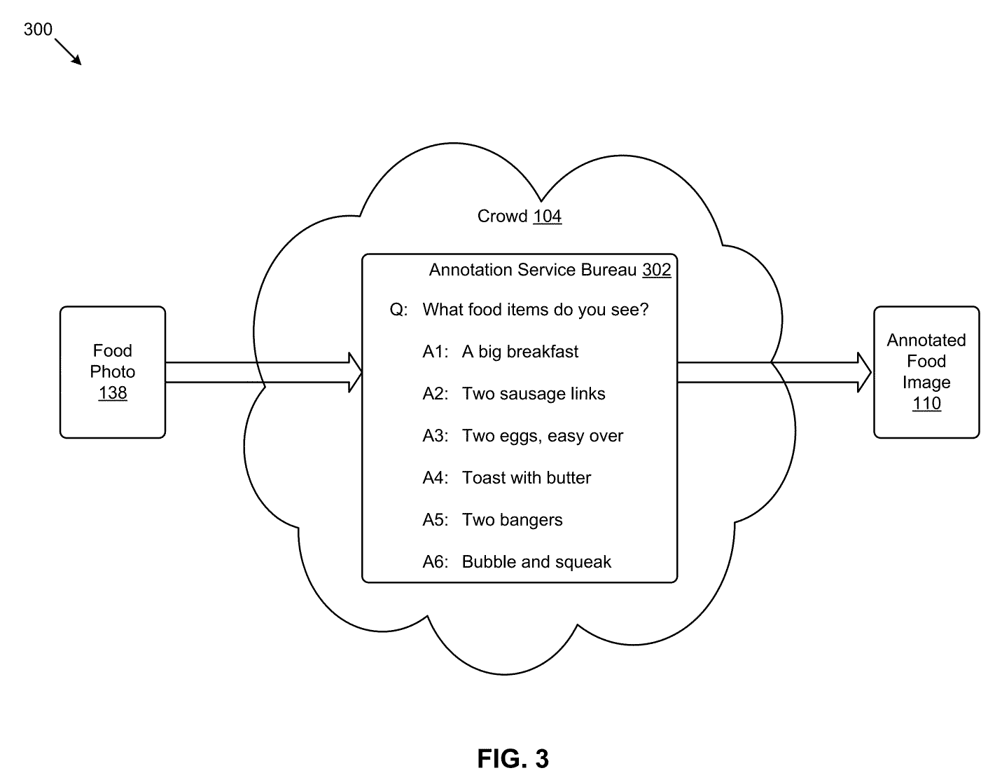

FIG. 3 shows a transformation process 300 as implemented by a service bureau in conjunction with a wellness program that uses crowdsourcing to determine nutritional content of foods depicted in an image. As an option, one or more instances of transformation process 300 or any aspect thereof may be implemented in the context of the architecture and functionality of the embodiments described herein. Also, the transformation process 300 or any aspect thereof may be implemented in any desired environment.

The transformation process 300 depicts a transformation where a food photo 138 is transmitted to an annotation service bureau 302 for transformation into an annotated food image. The annotation service bureau might perform crowdsourcing activities within particular standards and/or with particular rigor. In some cases, the annotation service bureau might produce tagged data that follows a particular syntax and/or schema and/or that conforms to specific grammar or that carries particular semantics.

As shown, the annotation service bureau 302 asks questions about the food photo (e.g., “What food items do you see?”) and records responses in the form of submitted answers to the question(s). Strictly as an example, answers might comprise a generic description (e.g., “a big breakfast”, etc.), or might be specific to an identified food item and quantity (e.g., “two sausage links”, “two bangers”, etc.). In some cases the food item might be described in some detail, possibly including the presence or absence of condiments and/or observation of a preparation method or methods (e.g., “two eggs easy over”, “toast with butter”). In some cases a description might use regional descriptions, and/or slang and/or multiple languages across multiple responses, or even within a particular response. For example, a generic description for a photo of a big breakfast depicting vegetables and sausages might be characterized by a regional or common name description (e.g., “bubble and squeak”).

As heretofore described, attributes of the meal can be identified or offered by members of the crowd (e.g., the service bureau), and attributes of the meal that are deemed to be statistically reliable and/or trending toward a consensus can be used in recording aspects of the meal on behalf of the user. The characteristics that are used to deem an answer as statistically reliable and/or trending toward a consensus are configurable. Different configurations might be employed based on the makeup and/or geographic centroid of the crowd or service bureau. Moreover, different selections of syntax, schema, and semantics can be used in different data flows and/or in different environments. An XML-based example of a syntax, a schema, and corresponding semantics are discussed as follows.

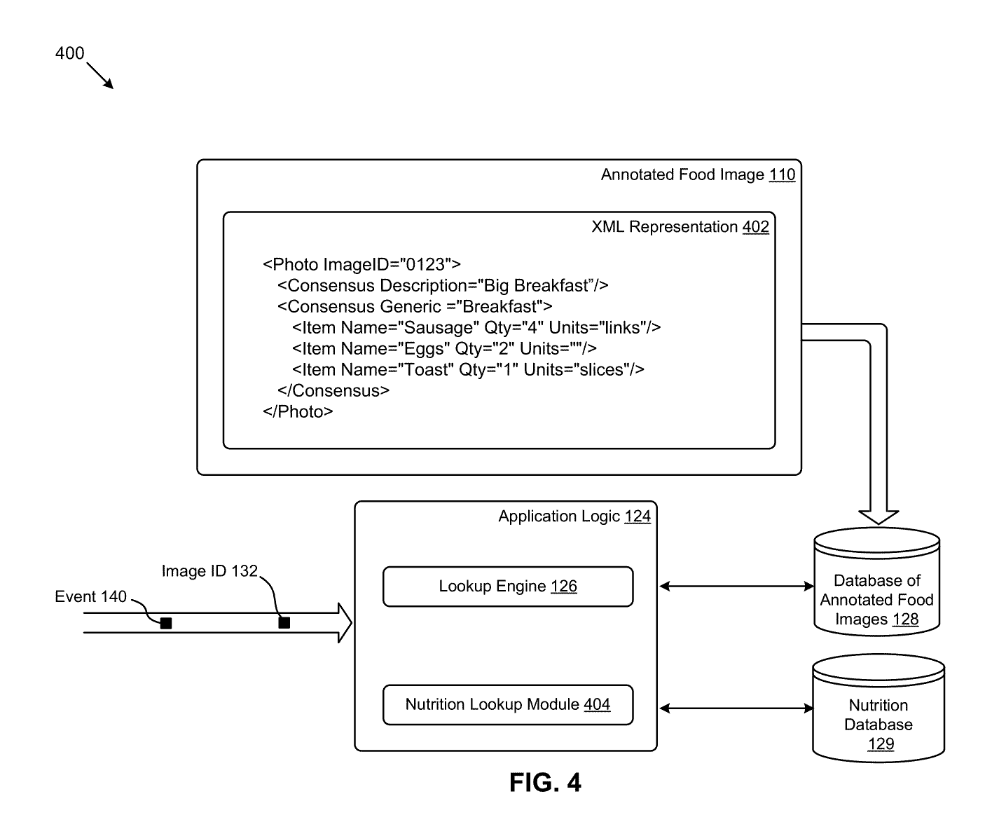

FIG. 4 presents a data flow 400 of an XML data item within a wellness program that uses crowdsourcing to determine nutritional content of foods depicted in an image. As an option, one or more instances of data flow 400 or any aspect thereof may be implemented in the context of the architecture and functionality of the embodiments described herein. Also, the data flow 400 or any aspect thereof may be implemented in any desired environment.

As shown in FIG. 4, an event 140 and a respective image ID 132 are received by the shown application logic 124. The calories deemed as being consumed contemporaneously with the timing of the event are retrieved by retrieving the crowdsourced tags corresponding to the given image ID (e.g., using lookup engine 126), and then, based on the retrieved crowdsourced tag or tags, the caloric content is retrieved from the nutrition database 129 (e.g., using nutrition lookup module 404). Strictly as one example of this flow, the event 140 and/or a respective image ID 132 can be used in a query to retrieve the attributes, elements, and/or any other manner of tags pertaining to the image ID. If an attribute, elements, and/or any other manner of tags pertaining to the image ID include the text value, “two sausage links”, then a query to the nutrition database 129 might return a listing of nutrition, such as “50 grams of protein, “200 grams of fat”, etc.). Such a listing can be used to present to a user for tracking and recommendations. Text values might be smoothed by using the aforementioned thesaurus and/or any other semantic smoothing techniques.

As another example, as shown in the XML representation 402, if a tag (e.g., an XLM attribute) indicates the text, “Big breakfast” (see the tagging of the “Description” attribute in XML element “Consensus”), then a query to the nutrition database 129 might return a listing of a caloric range pertaining to a big breakfast. Such a returned caloric range might be reconciled with items described in using the Item element. In some cases, the Description attribute might be present (or absent) and in some cases the Item elements might be present (or absent) and/or might be complete (or incomplete).

The calories and or nutrition might be presented to the user, possibly in a tracking user interface 122. One embodiment of a tracking user interface is shown and discussed as pertaining to the following figures.

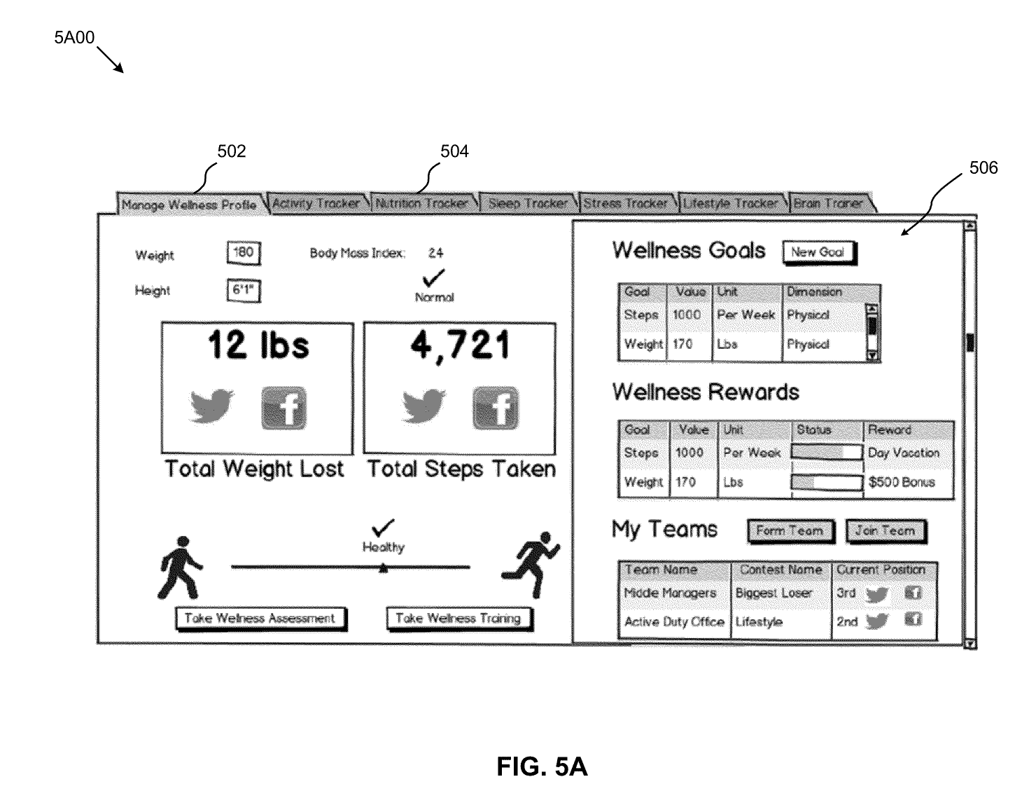

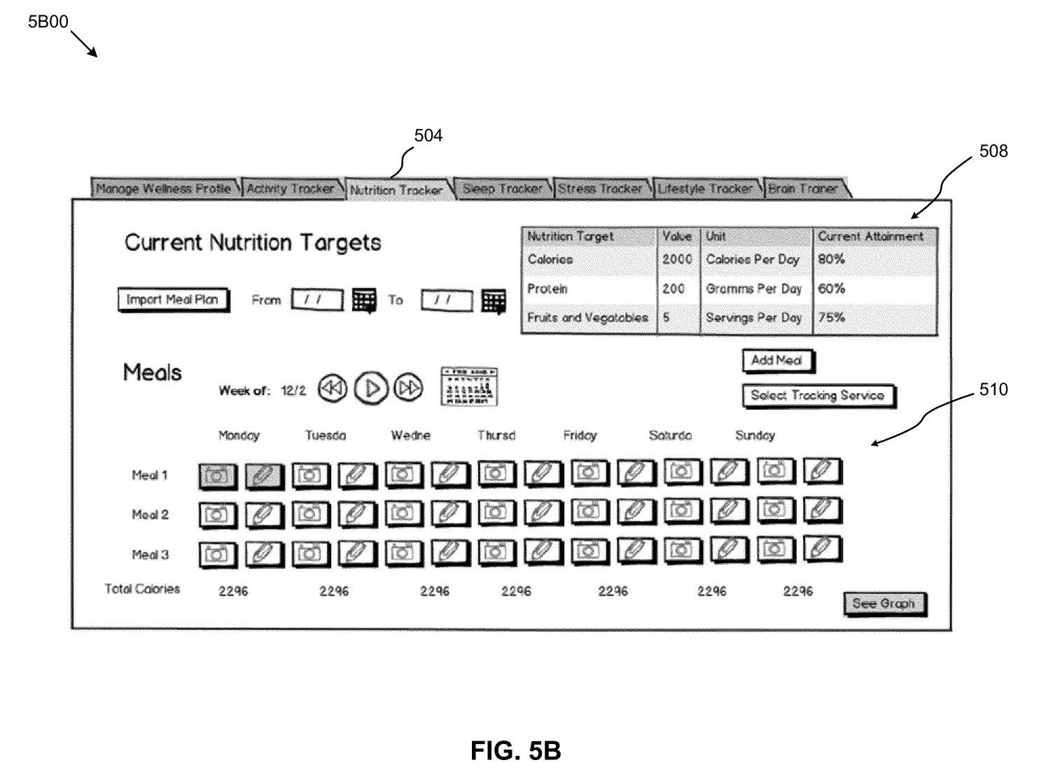

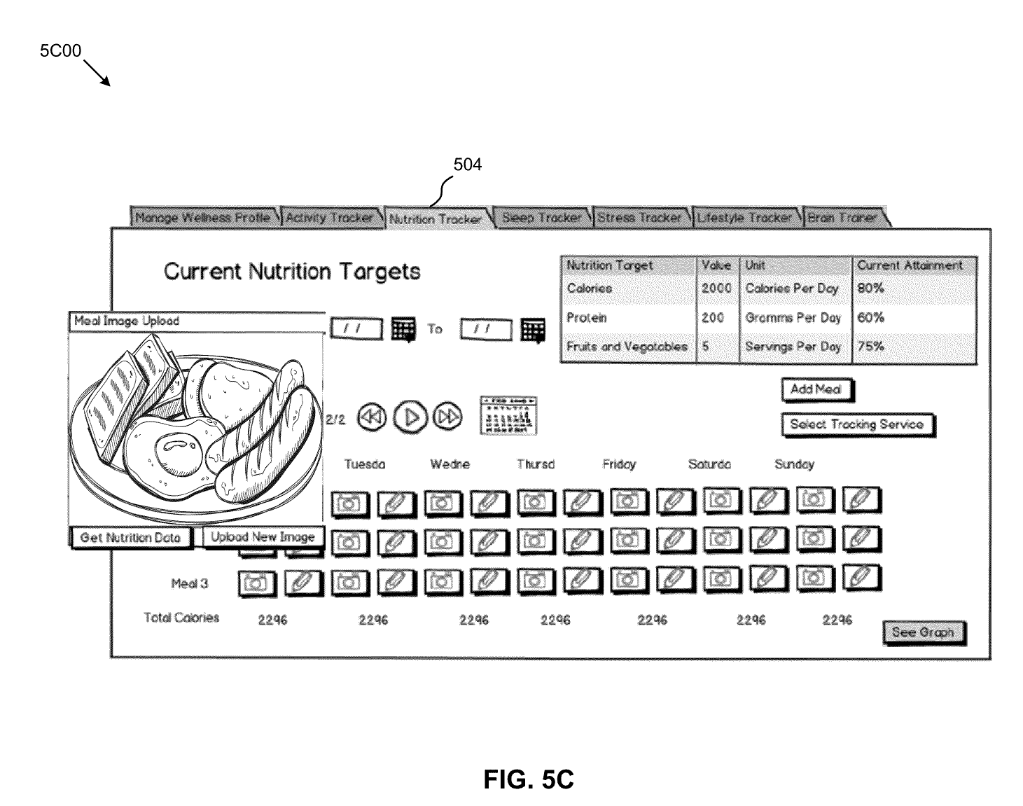

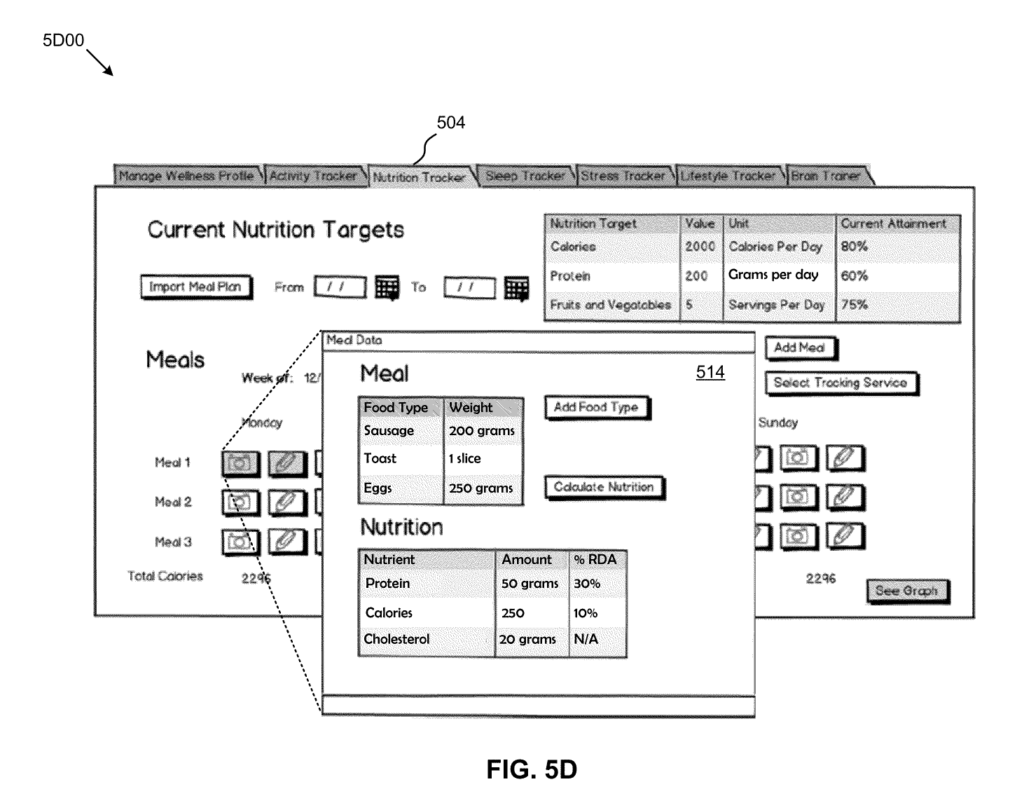

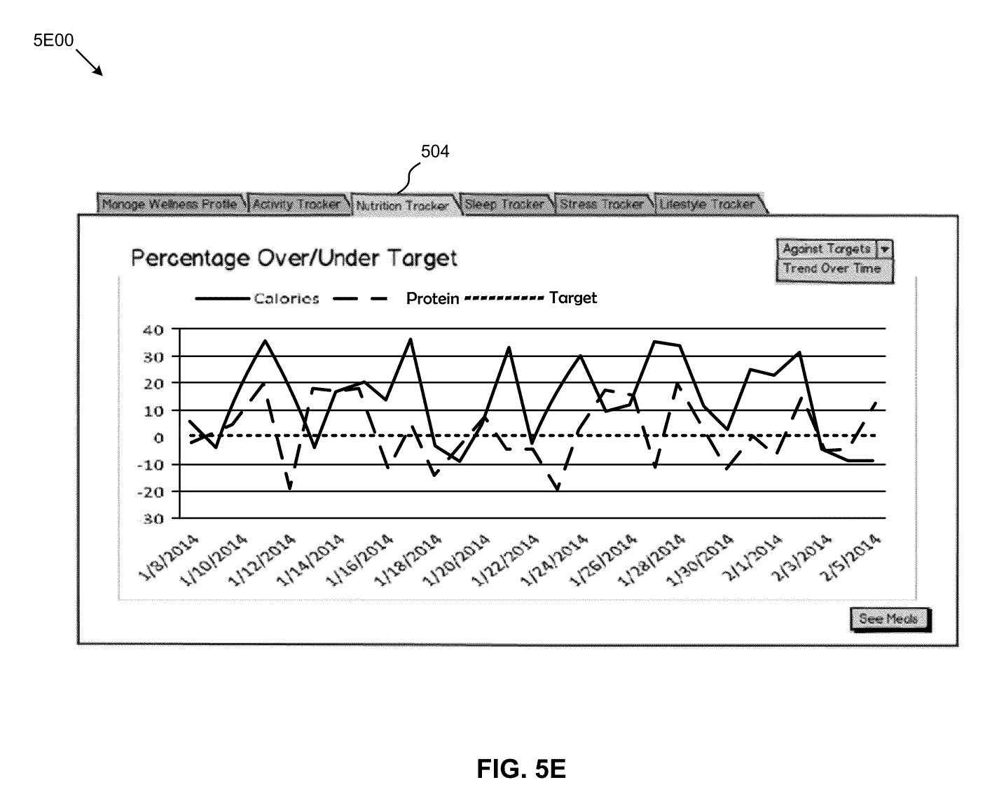

FIG. 5A presents a control panel user interface 5A00 as used within a wellness program that uses crowdsourcing to determine nutritional content of foods depicted in an image. As an option, one or more instances of control panel user interface 5A00 or any aspect thereof may be implemented in the context of the architecture and functionality of the embodiments described herein. Also, the control panel user interface 5A00 or any aspect thereof may be implemented in any desired environment.

As shown in FIG. 5A, the control panel user interface 5A00 includes multiple tabs, such as a profile tab 502 (e.g., see the tab labeled as “Manage Wellness Profile”), and such as a tracker tab 504 (e.g., see the tab labeled as “Nutrition Tracker”).

The information presented under a profile tab 502 might comprise personal characteristics of the user, including wellness goals 506, wellness rewards, team composition, weight loss progress and/or totals, activity progress and/or totals, and other aspects of a user.

The tracker tab 504 can be clicked or touched so as to bring up a nutrition target user interface.

FIG. 5B presents a nutrition target user interface 5B00 as used within a wellness program that uses crowdsourcing to determine nutritional content of foods depicted in an image. As an option, one or more instances of nutrition target user interface 5B00 or any aspect thereof may be implemented in the context of the architecture and functionality of the embodiments described herein. Also, the nutrition target user interface 5B00 or any aspect thereof may be implemented in any desired environment.

As shown in FIG. 5B, the user's nutrition targets can be presented in correspondence to a time period, including a past period, and/or a portion of a past period, and a portion of a future period. A nutrition tracker chart 508 presents nutrition dimensions, values, units, and a measure of attainment (e.g., by value, or by percent, as shown).

In some embodiments a series of events (e.g., Breakfast, Lunch, Dinner, or Meal 1, Meal 2, Meal 3, etc.) can be presented in a tracking array 510. In some cases historical events (this morning's breakfast) or predicted events (tomorrow's dinner) are shown spanning a time period. The time period and characteristics of the events are configurable.

In exemplary cases, an event that falls in a shown time period can be clicked or touched, and various characteristics of that event can be shown graphically (e.g., as a photo, or as a dynamically-generated table). In the example discussed hereunder, Monday's breakfast included toast, sausage, eggs, and ham. The user used a photo upload user interface to facilitate taking a photo of the breakfast. One example of a photo upload interface is depicted in the following FIG. 5C. In further embodiments, a meal plan can be adjusted to relate to schedules and/or characteristics of the user that impact food intake and/or goal-setting, and/or tracking techniques. For example, a person who is working a night shift for a short period, might tailor food intake to include a high-carbohydrate meal in the late afternoon or early evening (e.g., to emulate normal diurnal cycle of high-carbohydrate breakfasts), and a high-protein meal around midnight (e.g., to emulate normal diurnal cycle of high-protein dinner). In some embodiments, a background process can retrieve a user's meal plan, and can serve to provide timely prompts to a user to post a food photo. Such a prompt can be provided through any known means such a through a user's choices of one or more communication channels (e.g., texting, short messaging SMS, email, social media postings, tweets, etc.).

Such data gathering can be accomplished within wellness application environment 1B00 so as to adjust meal reminders to schedules and/or to relate nutritional intake to schedules and/or to relate nutritional tracking and goals to characteristics of the user.

Further, the burden of correlating any of the aforementioned schedules and/or characteristics of a user to a nutrition plan can be facilitated by the presence of certain data items within a wellness application environment 1B00. For example, a wellness profile 103 can store work and vacation schedules as well as any aspects of the user as the user may wish to use in goal-setting and tracking. The crowd and consensus processor can be used to receive recommendations from a crowd. For example, an uploader can be used to transmit portions of wellness profile to the crowd repository. Wellness program recommendations can be received from the crowd, and the wellness program recommendations from the crowd can be correlated using a consensus processor. In some cases, successful tracking of progress to a goal can be demonstrated to an insurance carrier (e.g., by transmitting documentation pertaining to tracking of progress to a goal), and the insurance carrier might reduce a premium amount.

FIG. 5C presents a photo upload user interface 5C00 as used within a wellness program that uses crowdsourcing to determine nutritional content of foods depicted in an image. As an option, one or more instances of photo upload user interface 5C00 or any aspect thereof may be implemented in the context of the architecture and functionality of the embodiments described herein. Also, the photo upload user interface 5C00 or any aspect thereof may be implemented in any desired environment.

As previously mentioned, an event that falls in a shown time period can be clicked or touched, and various characteristics of that event can be shown graphically. In the example of FIG. 5C, the user clicked on the event icon corresponding to Monday's breakfast, and a user interface dialog assists the user to capture a food photo 138.

In some cases, the food photo can be retrieved from a user's photo stream or the user's cloud repository. In some cases, a wellness application is configured with a smart phone app, which app serves to upload the food photo to a repository (e.g., defined by a URL) for subsequent access by a crowd. A user can allow (or deny) access to location services (e.g., via GPS or triangulation), and can co-upload other images that give the crowd participant some situational context. For example, a photo of a “big burger combo meal” might only depict the top portion of a sesame bun—and not any of the meat and/or cheese contents that would be consumed. While a particular crow participant might regard this to be by itself ambiguous, if a co-uploaded image included the name and/or setting of the dispensary (e.g., a photo of a “Big Burger Franchise” location), then a crowd source participant might be able to identify the foodstuff in the photo unambiguously as a “big burger combo meal”. Other information can be provided together with an uploaded image, and/or other information can be provided in a separate co-uploaded image. For example, the additional information might include time of day, or the name of the wireless network being used and/or the names of other co-located wireless networks. In some cases the name of the establishment can be determined from context, and can be provided in an upload. For example, the name of a wireless network might contain the name of the establishment. Any of the aforementioned information can be included as a part of a food image, and/or can be captured and/or transmitted as metadata. Such metadata can comprise a GPS coordinate (e.g., longitude and latitude), an establishment name (e.g. as a text string or as an image), a wireless network name, and/or a timestamp.

Referring to FIG. 1A, and the data flow 1A00, crowdsourcing is used to determine nutritional content of foods depicted in the food photo. The food photo is transformed into an annotated food image, which annotations contain any number of instances of a food type 134, and/or any number of respective instances of a food quantity 136. The annotations can be used to query various nutritional aspects of the food in the food photo, and some or all of such nutritional aspects are deemed as a nutrition corresponding to the given food photo. A given event may have an event icon, and the event icon can be highlighted so as to depict if the event has been recorded (e.g., a food photo has been uploaded). A given event icon may have a related nutrition icon that pertains to aspects of nutrition corresponding to the given event. Correspondence can be shown in many ways. The following figure depicts one possible correspondence using a pop-up window responsive to a click or touch of the nutrition icon.

FIG. 5D presents a nutrition correspondence user interface 5D00 as used within a wellness program that uses crowdsourcing to determine nutritional content of foods depicted in an image. As an option, one or more instances of nutrition correspondence user interface 5D00 or any aspect thereof may be implemented in the context of the architecture and functionality of the embodiments described herein. Also, the nutrition correspondence user interface 5D00 or any aspect thereof may be implemented in any desired environment.

As shown in FIG. 5D, a pop-up window 514 appears in response to a click or touch of the nutrition icon. The pop-up describes the meal using the crowdsourced tags. In exemplary cases, the nutritional value of the meal is presented in several categories. For example, the nutritional value of the meal can include a breakdown into protein, calories, cholesterol, and can further provide an indication of minimum daily requirements and/or amounts in excess of daily norms. Tracking of actual intake as compared with a target can be shown in a chart, as is presently discussed.

In addition to uploading food images to the crowd, any aspects of a user's wellness program (e.g., any aspects shown in tracker tab 504) can be uploaded to the crowd for comment. In some cases crowd participants can serve as wellness coaches, and might comment on a particular user's program. Further, components within the consensus processor subsystem 200 (e.g., consensus processor 111) might be used to correlate varied responses from the crowd.

FIG. 5E presents a nutrition tracker user interface 5E00 as used within a wellness program that uses crowdsourcing to determine nutritional content of foods depicted in an image. As an option, one or more instances of nutrition tracker user interface 5E00 or any aspect thereof may be implemented in the context of the architecture and functionality of the embodiments described herein. Also, the nutrition tracker user interface 5E00 or any aspect thereof may be implemented in any desired environment.

A user's actual intake of food based on a series of food photos, and based on the heretofore-described lookups as compared with a target, can be shown in a chart. In this example, the chart is presented under the tracker tab 504.

In this example, the intake of “Calories” and “Protein” are shown as compared with a “Target” amount. In other instances, other intake amounts as may be pictured in a food photo (e.g., cups of coffee) may be shown on the same or a different chart. A chart such as exemplified in nutrition tracker user interface 5E00 can track any sorts of or combinations of intake, and a chart such as exemplified in nutrition tracker user interface 5E00 can track over any time period and/or time period granularity.

### ADDITIONAL EMBODIMENTS OF THE DISCLOSURE

### Additional Practical Application Examples

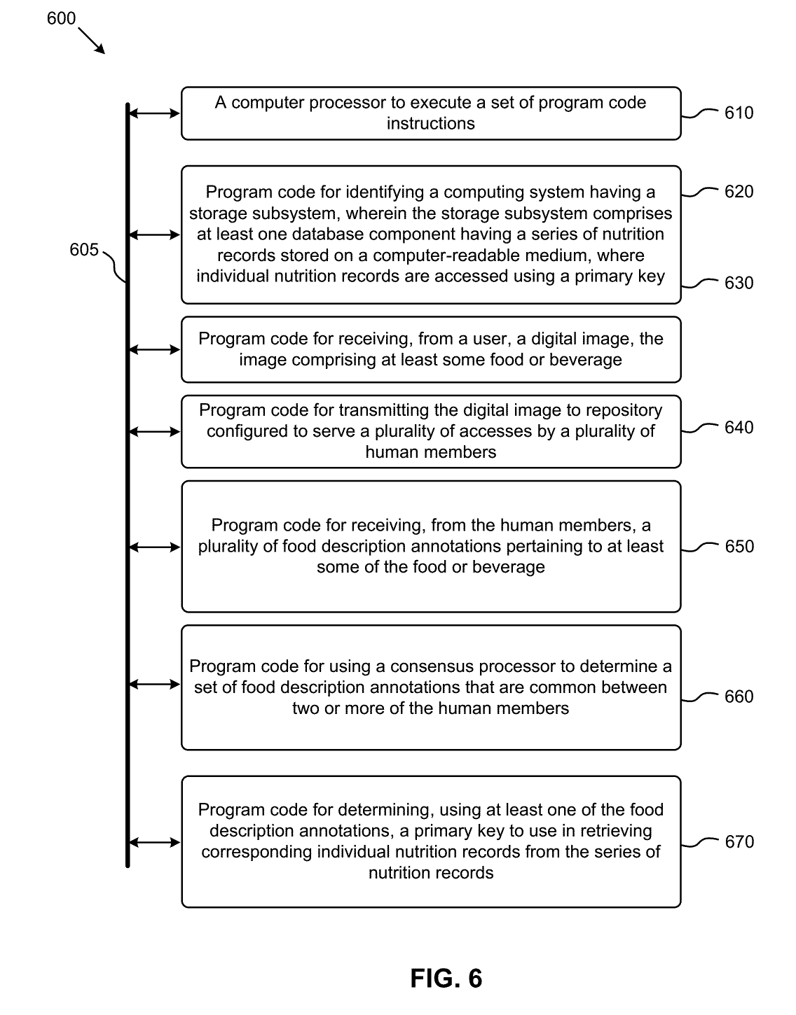

FIG. 6 is a block diagram of a system for using crowdsourcing to determine nutritional content of foods depicted in an image, according to some embodiments. As an option, the present system 600 may be implemented in the context of the architecture and functionality of the embodiments described herein. Of course, however, the system 600 or any operation therein may be carried out in any desired environment. As shown, system 600 comprises at least one processor and at least one memory, the memory serving to store program instructions corresponding to the operations of the system. As shown, an operation can be implemented in whole or in part using program instructions accessible by a module. The modules are connected to a communication path 605, and any operation can communicate with other operations over communication path 605. The modules of the system can, individually or in combination, perform method operations within system 600. Any operations performed within system 600 may be performed in any order unless as may be specified in the claims. The embodiment of FIG. 6 implements a portion of a computer system, shown as system 600, comprising a computer processor to execute a set of program code instructions (see module 610) and modules for accessing memory to hold program code instructions to perform: identifying a computing system having a storage subsystem, wherein the storage subsystem comprises at least one database component having a series of nutrition records stored on a computer-readable medium, where individual nutrition records are accessed using a primary key (see module 620); receiving, from a user, a digital image, the image comprising at least some food or beverage items (see module 630); transmitting the digital image to repository configured to serve a plurality of accesses by a plurality of human members (see module 640); receiving, from the human members, a plurality of food description annotations pertaining to at least some of the food or beverage items (see module 650); using a consensus processor to determine a set of food description annotations that are common (e.g., similar or partially identical, or identical, or otherwise shared) between two or more of the human members (see module 660). The nutritional value of the food or beverage is looked-up and processed within module 670. The look-up uses at least some portions of the food description annotations, to form a primary key which in turn is used to access corresponding individual nutrition records from the series of nutrition records (see module 670). Nutritional values may be added and/or a range of nutritional values may be summarized in a display to be presented to a user.

### System Architecture Overview

### Additional System Architecture Examples

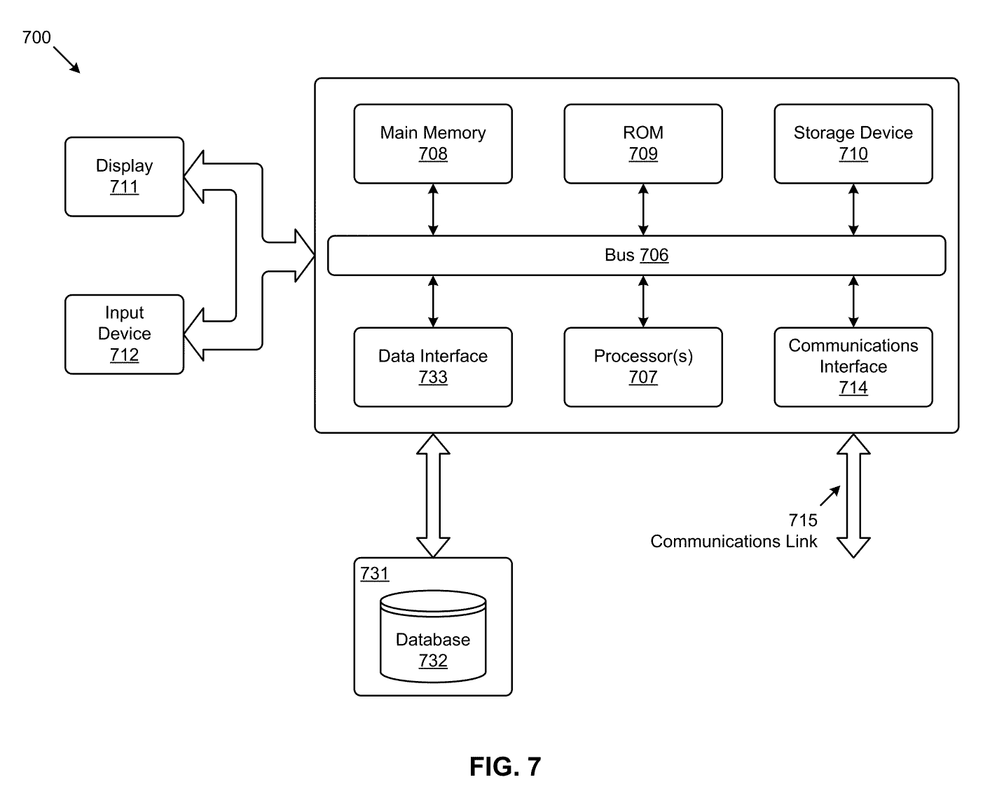

FIG. 7 depicts a block diagram of an instance of a computer system 700 suitable for implementing embodiments of the present disclosure. Computer system 700 includes a bus 706 or other communication mechanism for communicating information, which interconnects subsystems and devices, such as a processor 707, a system memory 708 (e.g., RAM), a static storage device (e.g., ROM 709), a disk drive 710 (e.g., magnetic or optical), a data interface 733, a communication interface 714 (e.g., modem or Ethernet card), a display 711 (e.g., CRT or LCD), input devices 712 (e.g., keyboard, cursor control), and an external data repository 731.

According to one embodiment of the disclosure, computer system 700 performs specific operations by processor 707 executing one or more sequences of one or more instructions contained in system memory 708. Such instructions may be read into system memory 708 from another computer readable/usable medium, such as a static storage device or a disk drive 710. In alternative embodiments, hard-wired circuitry may be used in place of or in combination with software instructions to implement the disclosure. Thus, embodiments of the disclosure are not limited to any specific combination of hardware circuitry and/or software. In one embodiment, the term “logic” shall mean any combination of software or hardware that is used to implement all or part of the disclosure.

The term “computer readable medium” or “computer usable medium” as used herein refers to any medium that participates in providing instructions to processor 707 for execution. Such a medium may take many forms, including but not limited to, non-volatile media and volatile media. Non-volatile media includes, for example, optical or magnetic disks, such as disk drive 710. Volatile media includes dynamic memory, such as system memory 708.

Common forms of computer readable media includes, for example, floppy disk, flexible disk, hard disk, magnetic tape, or any other magnetic medium; CD-ROM or any other optical medium; punch cards, paper tape, or any other physical medium with patterns of holes; RAM, PROM, EPROM, FLASH-EPROM, or any other memory chip or cartridge, or any other non-transitory medium from which a computer can read data.

In an embodiment of the disclosure, execution of the sequences of instructions to practice the disclosure is performed by a single instance of the computer system 700. According to certain embodiments of the disclosure, two or more computer systems 700 coupled by a communications link 715 (e.g., LAN, PTSN, or wireless network) may perform the sequence of instructions required to practice the disclosure in coordination with one another.

Computer system 700 may transmit and receive messages, data, and instructions, including programs (e.g., application code), through communications link 715 and communication interface 714. Received program code may be executed by processor 707 as it is received and/or stored in disk drive 710 or other non-volatile storage for later execution. Computer system 700 may communicate through a data interface 733 to a database 732 on an external data repository 731. Data items in database 732 can be accessed using a primary key (e.g., a relational database primary key). A module as used herein can be implemented using any mix of any portions of the system memory 708, and any extent of hard-wired circuitry including hard-wired circuitry embodied as a processor 707.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are, accordingly, to be regarded in an illustrative sense rather than in a restrictive sense.

What is claimed is:

1. A method comprising:
identifying a computing system having a storage subsystem, wherein the storage subsystem comprises at least one database component having a series of nutrition records stored on a computer-readable medium, where individual nutrition records are accessed using at least a primary key;
receiving, from a user, a digital image, the image comprising at least one food or beverage item;
transmitting the digital image to a repository configured to serve a plurality of accesses by a plurality of human members;
receiving, from the human members, a plurality of food description annotations pertaining to the at least one food or beverage item; and
determining, using at least one of the food description annotations, a nutrition record primary key to use in retrieving corresponding individual nutrition records from the series of nutrition records.

2. The method of claim 1, further comprising determining a set of food description annotations that are shared between two or more of the human members.

3. The method of claim 1, further comprising retrieving, using the nutrition record primary key, at least one individual nutrition record from the series of nutrition records.

4. The method of claim 1, further comprising:
transmitting at least some portions of a wellness profile to the repository; and
receiving, from the human members, a plurality of wellness program recommendations.

5. The method of claim 4, further comprising correlating received wellness program recommendations from the human members.

6. The method of claim 1, wherein the digital image comprises metadata including at least one of, a GPS coordinate, an establishment name, a wireless network name, and a timestamp.

7. The method of claim 1, further comprising identifying a wellness profile pertaining to the user and storing at least one of the food description annotations in a progress tracking area of the wellness profile.

8. The method of claim 7, further comprising comparing information contained in the progress tracking area of the wellness profile to a wellness profile goal.

9. The method of claim 8, further comprising transmitting information pertaining to the progress tracking area with respect to the goal.

10. The method of claim 1, further comprising using the plurality of food description annotations pertaining to at least some of the food or beverage items to calculate a statistical confidence interval.

11. A computer program product embodied in a non-transitory computer readable medium, the computer readable medium having stored thereon a sequence of instructions which, when executed by a processor causes the processor to execute a process, the process comprising:
receiving, from a user, a digital image, the image comprising at least one food or beverage item;
transmitting the digital image to a repository configured to serve a plurality of accesses by a plurality of human members;
receiving, from the human members, a plurality of food description annotations pertaining to the at least one food or beverage item; and
determining, using at least one of the food description annotations, a nutrition record primary key to use in retrieving corresponding individual nutrition records from a series of nutrition records.

12. The computer program of claim 11, further comprising program code for determining a set of food description annotations that are shared between two or more of the human members.

13. The computer program of claim 11, further comprising program code for retrieving, using the nutrition record primary key, at least one individual nutrition record from the series of nutrition records.

14. The computer program of claim 11, further comprising program code for:
transmitting at least some portions of a wellness profile to the repository; and
receiving, from the human members, a plurality of wellness program recommendations.

15. The computer program of claim 14, further comprising program code for correlating received wellness program recommendations from the human members.

16. The computer program of claim 11, wherein the digital image comprises metadata including at least one of, a GPS coordinate, an establishment name, a wireless network name, and a timestamp.

17. The computer program of claim 11, further comprising program code for identifying a wellness profile pertaining to the user and storing at least one of the food description annotations in a progress tracking area of the wellness profile.

18. The computer program of claim 17, further comprising program code for transmitting information pertaining to the progress tracking area with respect to the goal.

19. A system comprising
an uploader module to receive a digital image, the image comprising at least one food or beverage item, and to transmit the digital image to a repository configured to serve a plurality of accesses by a plurality of human members;
a processor to receive a plurality of food description annotations pertaining to the at least one food or beverage item; and
application logic to determine, using at least one of the food description annotations, a nutrition record primary key to use in retrieving corresponding individual nutrition records from a series of nutrition records.

20. The system of claim 19, further comprising further comprising a consensus processor to determine a set of food description annotations that are shared between two or more of the human members.
